(19) United States
(12) Patent Application Publication
(10) Pub. No.: US 2006/0194593 A1
(43) Pub. Date: Aug. 31, 2006

(54) Method for locating a mobile unit in a wireless telecommnunication network

(75) Inventors: Lawrence M. Drabeck, Oceanport, NJ (US); Michael J. Flanagan, Chester, NJ (US)

Correspondence Address: WILLIAMS, MORGAN & AMERSON, 10333 RICHMOND, SUITE 1100, HOUSTON, TX, 77042, US

(73) Assignee: Lucent Technologies, Inc.

(21) Appl. No.: 11/066,111

(22) Filed: Feb. 25, 2005

(51) Int. Cl. H04Q 7/20

(52) U.S. Cl. 455/456.5; 455/456.1

(57) ABSTRACT

The present invention provides a method for locating mobile units in a wireless telecommunication network. The method includes determining at least one distance associated with a mobile unit in communication with at least one base station in a wireless telecommunications network, determining a first location based on said at least one distance, and selecting a plurality of second locations based on the first location. The method also includes determining a plurality of likelihoods that the mobile unit is at each of the plurality of second locations.

### BACKGROUND OF THE INVENTION

1. Field of the Invention

This invention relates generally to telecommunication systems, and, more particularly, to wireless telecommunication systems.

2. Description of the Related Art

Wireless telecommunications systems may be used to connect mobile units (sometimes also referred to as user equipment or UE) to a network. Exemplary mobile units may include mobile phones, personal data assistants, smart phones, text messaging devices, laptop computers, desktop computers, and the like. A mobile unit typically forms an air interface with a base station (or node-B) in the network. For example, a mobile phone may form a communication link over an air interface that operates according to a Code Division Multiple Access (CDMA or CDMA 2000) protocol. Each base station in the network typically provides service to mobile units within a geographical area, or cell, proximate to the base station. In some cases, the base station may include one or more directional antennas that provide service to mobile units within a sector of the cell associated with the directional antenna.

Although base stations may determine whether or not a mobile unit is within the cell, or a sector of the cell, base stations are not generally able to determine the location of the mobile unit within the cell or the sector of the cell. Since a typical cell may have a radius as large as 10 kilometers, the inability to determine the position of mobile units within the cell (or sector) results in a significant uncertainty regarding the location of the mobile unit and/or the user of the mobile unit. These uncertainties may limit the ability of wireless telecommunications service providers to provide services via the wireless communication network, as well as limiting the ability to design, optimize, and/or plan the network. For example, service providers may not be able to locate users that make emergency 911 calls from a mobile phone. For another example, service providers may not be able to form detailed user distribution maps that could be used to optimize the deployment and/or operation of base stations, as well as place new base stations more efficiently.

The present invention is directed to addressing the effects of one or more of the problems set forth above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for locating mobile units in a wireless telecommunication network. The method includes determining at least one distance associated with a mobile unit in communication with at least one base station in a wireless telecommunications network, determining a first location based on said at least one distance, and selecting a plurality of second locations based on the first location. The method also includes determining a plurality of likelihoods that the mobile unit is at each of the plurality of second locations.

### BRIEF DESCRIPTION OF THE DRAWINGS

The invention may be understood by reference to the following description taken in conjunction with the accompanying drawings, in which like reference numerals identify like elements, and in which:

FIG. 1 shows a wireless telecommunications network, in accordance with the present invention;

FIG. 2 conceptually illustrates one exemplary embodiment of a wireless telecommunications network coverage area that includes distances associated with a mobile unit in communication with multiple base stations, in accordance with the present invention; and

FIG. 3 conceptually illustrates one exemplary embodiment of a method of locating a mobile unit in a wireless telecommunication coverage area, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

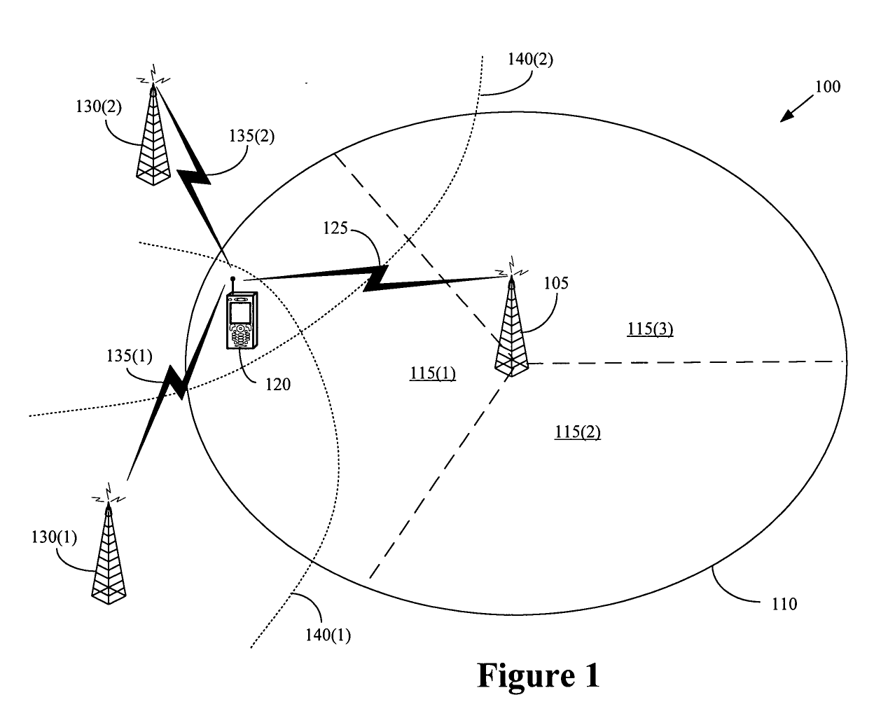

Referring now to FIG. 1, a wireless telecommunications network 100 is shown. In the illustrated embodiment, the wireless telecommunications network 100 includes a base station 105 that provides wireless telecommunication services to a cell 110 that includes three sectors 115(1-3). The base station 105 may include three or more beamforming antennas (not shown) with a given beamwidth to provide the wireless telecommunications services to the three sectors 115(1-3). However, the present invention is not limited to the base station 105 providing wireless telecommunications services to cell 110 including three sectors 115(1-3). In alternative embodiments, the base station 105 may provide wireless telecommunications services to a cell 110 having any desirable number of sectors 115(1-3). For example, the cell 110 may include more or fewer sectors 115 (1-3) that are serviced by any desirable number of beamforming antennas. For another example, the cell 110 may constitute a single sector that is serviced by one or more omnidirectional antennas.

One or more mobile units 120 (only one shown in FIG. 1) may communicate with the base station 105 over an air interface 125. In one embodiment, the mobile unit 120 communicates with the base station 105 over the air interface 125 according to a Code Division Multiple Access (CDMA) protocol. However, persons of ordinary skill in the art having benefit of the present disclosure should appreciate that the present invention is not limited to air interfaces 125 that operate according to CDMA protocols. In alternative embodiments, the air interface 125 may operate according to any desirable protocol including, but not limited to, a Universal Mobile Telecommunication Service (UMTS) protocol, a Global System for Mobile telecommunications (GSM) protocol, a Personal Cellular Service (PCS) protocol, a Time Division Multiple Access (TDMA) protocol, and a Frequency Division Multiple Access (FDMA) protocol.

Network information associated with the mobile unit 120 may be accessed by the wireless telecommunications network 100. In one embodiment, the mobile unit 120 provides network information to the base station 105. For example, a CDMA handoff trigger may cause the mobile unit 120 to provide handoff trigger data that includes network information derived from a pilot signal. The base station 105 may also collect, measure, and/or access network information from the wireless telecommunications network 100. In embodiments that use CDMA protocols, a Per Call Measurement Data (PCMD) network feature and other software programs may allow access to CDMA network quantities such as serving sectors, round trip delays, chip delay offsets, E_{c}/Iₒ values, and the like. In various other embodiments, the network information may also include class of service data (voice, data, short message service or SMS) associated with the mobile unit 120, call conclusion status (normal, blocked, dropped), base station locations (e.g. latitudes and/or longitude), antenna point angles or azimuths, antenna beamwidths, and the like.

In some embodiments, such as the embodiment shown in FIG. 1, the mobile unit 120 also communicates with one or more secondary (or serving) base stations 130(1-2) over air interfaces 135(1-2), respectively. For example, the serving base stations 130(1-2) may provide wireless service to cells 140(1-2), which may partially or completely overlap with one or more sectors 115(1-3) of the cell 110. As discussed above, the air interfaces 135(1-2) may operate according to any desirable protocol. The mobile unit 120 and/or the serving base stations 130(1-2) may also access and/or determine network information, such as the network information described above. In one embodiment, the mobile unit 120 may be handed off between the cells 110, 140(1-2) and/or the sectors 115(1-3). For CDMA type systems, handoffs between cells are commonly referred to as “soft” handoffs and handoffs between sectors of a cell are commonly referred to as “softer” handoffs.

The base station 105 is capable of determining a location of one or more mobile units 105 in the wireless telecommunications network 100. In one embodiment, the base station 120 determines one or more distances associated with the mobile unit 120. For example, the base station 105 may determine the distance from the location of the base station 105 to the mobile unit 120. For another example, the base station 105 may determine distances from locations of the serving base stations 130(1-2) to the mobile unit 120. The base station 105 may then determine a first location using the one or more distances. For example, one or more circles may be constructed using the distances and the first location may be selected using intersections of the circles. If the circles intersect at more than one point, then the first location may be selected from the intersection points based on a likelihood function. The base station 105 may select a plurality of second locations, such as a grid of locations, based on the first location and then determine a likelihood that the mobile unit 120 is at each of the plurality of second locations, as will be described in detail below. In one embodiment, a most likely location may be selected from the second locations based on the likelihoods.

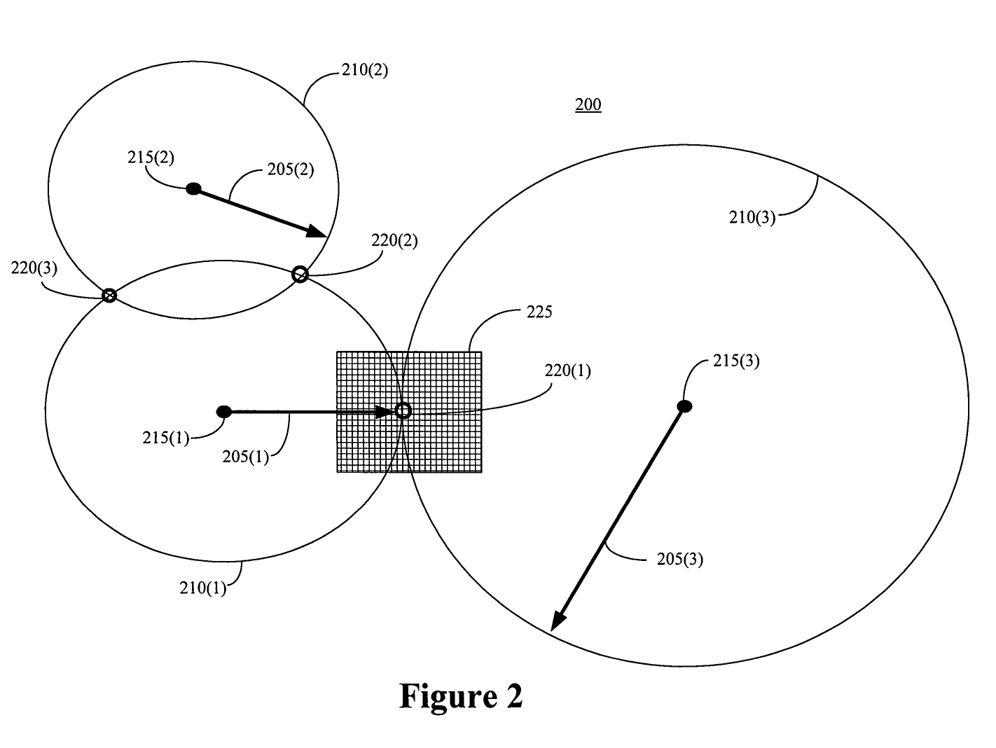

FIG. 2 conceptually illustrates one exemplary embodiment of a wireless telecommunications network coverage area 200 that includes distances 205(1-3) associated with a mobile unit in communication with three base stations, such as the mobile unit 120 and the primary and secondary base stations 105, 130(1-2) shown in FIG. 1. In the illustrated embodiment, the distance 205(1) is associated with a primary cell (or sector) and the distances 205(2-3) are associated with serving cells (or sectors). The distances 205(1-3) can be calculated using network information. In embodiments in which the wireless telecommunications network operates according to a CDMA protocol, the network information includes information in a PCMD record. For example, the PCMD record may include information identifying N≧1 serving sectors, Sᵢ, i=0,1, . . . N, associated with each mobile unit. In this example, S₀ corresponds to the primary sector. The PCMD record may also include information identifying a reference sector, S_{R}, against which delay times may be calculated for the other sectors. The reference sector S_{R}ε{Sᵢ} and, in some embodiments, the reference sector S_{R}=S₀.

The PCMD record may also include information indicating round-trip-delay (RTD) information for the primary sector (in units of ⅛ chips) and delay difference information (Dᵢ) for each serving sector (in units of chips). The value of the delay difference information (Dᵢ) is zero for the reference sector. The delay difference information (Dᵢ) may be a signed quantity. In embodiments that include different reference and primary sectors, the delay difference information may be recalculated as if the primary sector was the reference sector (i.e., the difference between Dᵢ and D₀ becomes the new value of Dᵢ for all sectors). In the following discussion, the reference and the primary sectors are assumed to be identical (i.e., that D₀=0). Chip-level signal-to-noise-ratio information, Ec/Ioᵢ may also be included in the PCMD record.

In one embodiment, the distances 205 (1-3) are radii determined using the network information. For example, each sector may be associated with index i and a radial distance Rᵢ may be defined using the formula:
Rᵢ=k_{R}(RTD−B_{R})+k_{D}Dᵢ,
where k_{R}=15.25 meters corresponds to half the distance light travels in one eighth of a chip interval (when the chip rate is 1.2288 Mchips/sec), B_{R} is an RTD bias term (usually between 24 and 30, depending on the wireless telecommunications system), and k_{D}=244 meters is to the distance light travels in a chip interval. In the illustrated embodiment, half the distance light travels in one eighth of a chip interval in used to compute k_{R} because the RTD value corresponds to a round-trip whereas the radial distance Rᵢ represents a one-way distance. In the above embodiment, the distances 205 (1-3) represent estimated distances from one of the base stations to the mobile unit.

Circles 210(1-3) may be determined using the distances 205(1-3). In the illustrated embodiment, the circles 210(1-3) have a radius equal to the distances 205(1-3) and are centered on locations 215(1-3) within the wireless network coverage area 200. For example, the locations 215(1-3) may be proximate locations of the base stations providing service to the primary and/or serving sectors. The distances 205(1-3) may also be used to form vectors, such as indicated in FIG. 2. For example, the tail of the vector may be located on one of the locations 215(1-3) associated with a base station and the head of the vector may be located on one of the circles 210(1-3). The direction of the vector may be determined by the sector azimuth of a beamforming antenna to provide service to the sector.

The circles 210(1-3) intersect at points 220(1-3). Although the circles 210(1-3) shown in FIG. 2 intersect at points 220(1-3), this may not be true in all circumstances. Accordingly, in one embodiment, circles 210(1-3) may be considered to intersect if they lie within a specified tolerance of each other. Alternatively, circles 210(1-3) may not intersect and candidate points may be determined using other techniques. In one embodiment, if circles associated with any of the sectors under study do not intersect the primary circle 210(1), then the collection of data associated with these sectors may be discarded from consideration since substantial multipath or erroneous input data may reduce the chance of successful geolocation of the mobile unit. To date, it appears that a small percentage of the data is discarded using this approach (i.e., <5% of the data is discarded due to this effect in a market with substantial terrain and dense urban propagation effects). In one embodiment, data associated with non-intersecting circles may be discarded and analysis of the remaining sectors may continue.

A mobile unit in communication with the base stations may be located at or near one of the points 220(1-3). Thus, a likelihood that the mobile unit is located at each of the points 220(1-3) may be determined and one of the points 220(1-3) may be selected as the most likely location for the mobile unit based on the likelihoods. In the CDMA embodiment, the likelihood that the mobile unit is located at one of the points 220(1-3) may be determined by evaluating each of the candidate points 220(1-3) according to how well they match the CDMA data record and/or other known network information including, but not limited to, base station locations, antenna point angles and beamwidths. It should be noted that the supplied network data may be imperfect due to quantization and noise effects. Therefore, a perfect match between multiple candidate points 220(1-3) may not be expected. Instead, a maximum likelihood strategy may be employed. For example, point 220(3) can be considered the least likely based on radial distance information since it would require the largest error in the distance 205(3). Points 220(1-2) require similar errors in the distances 205(2-3), respectively. Antenna information about each sector may be used to resolve this ambiguity. If the pointing angles of the sectors in FIG. 2 are denoted by the arrows associated with the distances 205(1-3) and the gain of the antennas is maximized in the direction of the arrow and decays as the direction moves away from the arrow, then point 220(1) is likely to be identified as the most likely point since it requires the least angular offset from each of the sector antennas.

Although the above discussion assumes that the most likely point may be determined using intersection points 220(1-3) of multiple circles 210(1-3), the present invention is not so limited. In alternative embodiments, a most likely point may be selected based on a single circle. For example, in the special case of softer-handoff, i.e. a handoff between sectors of a single cell served by a base station, a single circle with radius R₀ may be constructed about the base station of the primary sector. Then, relative antenna gains of the primary sector and secondary sector (in softer-handoff) for each point on the circle may be compared to observed differences in E_{c}/Iₒ for the same primary and secondary sectors. For example, a gain map may be used to compare the relative antenna gains to the observed differences in E_{c}/Iₒ. The most likely point may then be determined based on the comparison, e.g. the point having the relative antenna gain that is closest to the corresponding observed difference in E_{c}/Iₒ may be selected as the most likely point.

A second set of points is determined based upon the selected point, e.g. the point 220(1). In the illustrated embodiment, a grid 225 of points is positioned proximate to the point 220(1). Selecting the grid 225 may permit identification of a final best point that is not among the candidate set of points 220(1-3), which may help reduce the effects of uncertainties associated with the network data. In some embodiments, selecting the grid 225 may allow an accuracy improvement over the quantization constraints imposed on any one element of network data (e.g., the chip-level resolution of secondary delay differences). The size and/or the granularity of the grid 225 are matters of design choice. For example, the size and/or the granularity of the grid 225 may be selected as a function of the accuracy of the supplied data.

A likelihood evaluation is performed for each point in the grid 225 and a most likely point may be selected based on the likelihood evaluation. For example, a maximum likelihood function may be used to determine likelihoods for each point in the grid 225 and the point receiving the highest likelihood may be selected as the most likely point. In one embodiment, the likelihood information may be used for additional filtering of likelihood scores above a certain threshold. This may have the benefit of increasing the accuracy of the filtered set of points at the expense of reducing the size of the set.

In one embodiment, the likelihoods may be used to identify errors in network information. For example, the likelihoods may be used to identify errors in azimuths, beamwidths, base station locations, and the like since these types of errors will tend to substantially degrade the likelihoods. For example, some or all of the network information may be modified. Then the likelihoods may be recalculated, e.g. applying a maximum likelihood function to the modified network information. If the likelihoods are significantly improved, this may be taken as an indication of one or more errors in the network information. The modified network information may also be used to correct the one or more errors.

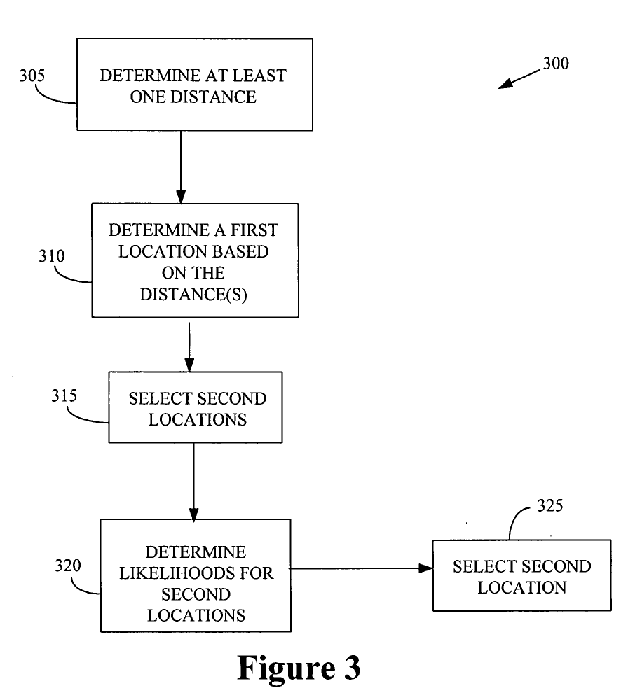

FIG. 3 conceptually illustrates one exemplary embodiment of a method 300 of locating a mobile unit in a wireless telecommunication coverage area. In the illustrated embodiment, at least one distance is determined (at 305). The distances are associated with a mobile unit in communication with at least one base station in a wireless telecommunications network. For example, as discussed above, one or more radii extending from the location of one or more base stations may be determined (at 305) using network information. A first location is then determined (at 310) based on the distances. If only one distance is available, the first locations may be determined (at 310) by applying a maximum likelihood function to points on a circle formed using the first distance. The maximum likelihood function may be formed using network information. If more than one distance is available, the first location may be determined (at 310) using one or more points at the intersection of circles formed from the distances and then applying a maximum likelihood function to the intersection points based on network information.

One or more second locations are then selected (at 315) using the first location. In one embodiment, the second locations are selected (at 315) to correspond to points in a grid centered on the first location. One or more likelihoods that the mobile unit is located at each of the second locations are determined (at 320). In one embodiment, a maximum likelihood function is used to determine (at 320) the one or more likelihoods. The maximum likelihood function that is used to determine (at 320) the one or more likelihoods associated with the second locations may be the same as the maximum likelihood function used to determine (at 310) the first location. However, the present invention is not so limited. In alternative embodiments, different maximum likelihood functions may be used to determine (at 310) the first location and to determine (at 320) the one or more likelihoods associated with the second locations. In one embodiment, one of the second locations is selected (at 325) as the most likely location for the mobile unit. For example, the second location having the largest likelihood may be selected (at 325) as the most likely location for the mobile unit.

Techniques for determining the various likelihoods, as well as the particular mathematical form of the maximum likelihood functions discussed above, are matters of design choice and persons of ordinary skill in the art should appreciate that any desirable likelihood functions may be used. However, experimentation has indicated that some maximum likelihood functions may be particularly useful in certain contexts. In one embodiment, a maximum likelihood function may be defined to take into account various factors that may be used to determine the likelihood that a mobile unit is located at a selected point. Various embodiments of the maximum likelihood function may take into account how well the point location agrees with the estimated distances for the sectors, how well the point location lies in the main lobes of the sectors, a confidence level associated with the point location given the E_{c}/Iₒ value for secondary/serving sector that sourced it, and the like. For example, the likelihood function for point P_{k,l} (provided by secondary/serving sector k) may be written as:

$$L ( {P}_{k , l} ) = {f}_{Ec / Io} ( Ec / {Io}_{k} ) \cdot {\prod }_{i = 0}^{N - 1} {f}_{R , i} ( \vert {r}_{k , l , i} - {R}_{i} \vert ) \cdot {f}_{A} ( {ϕ}_{k , l , i} , {α}_{i} , {β}_{i} ) ,$$

where r_{k,l,i} is the distance from point P_{k,l} to sector i, φ_{k,l,i} is the angle between due north and a line from sector i to the point P_{k,l}, αᵢ is the pointing angle of sector i, and βᵢ is the horizontal beamwidth for sector i. Instead of using the true joint probability density function (that integrates to unity over the multidimensional space under consideration), the likelihood function above is a normalized version whose maximum value equals unity. The function f_{Ec/Io} returns a value of unity for sufficiently large arguments (indicating high confidence with strong Ec/Io estimates) and returns values approaching zero for sufficiently small arguments. For example, the function f_{Ec/Io} may exponentially decrease as Ec/Io decreases.

In one embodiment of the maximum likelihood function, the function f_{R,i} may return a value of unity when the input argument is close to zero (indicating high confidence when the radial distance errors are small) and may return values approaching zero when the input argument becomes larger. A subscript i is used for this function because the errors may be scaled differently when dealing with the primary sector (i=0) compared to the secondary/serving sectors (i>0) due to different scales in the measured distance quantities (⅛ chips versus whole chips). The primary distance estimates (via RTD) tend to be more accurate than the secondary distances, and so errors in primary distance estimates may be penalized more heavily than commensurate errors in secondary distance estimates. In one embodiment, the input arguments to f_{R} will be zero when i=0 and i=k during the first step of this approach. This is because there is typically little or no error in the radial estimate of an intersecting point. However, there may be errors when evaluating radial estimates with other sectors.

In one embodiment of the maximum likelihood function, the function f_{A} returns a value close to unity when φ_{k,l,i} is within βᵢ/2 of the pointing azimuth, αᵢ. Conversely, the function f_{A} returns a value approaching zero as |φ_{k,l,i}−αᵢ|→180° (except for the special case of omni-directional antennas where f_{A} is unity for all φ_{k,l,i}). This has the effect of favoring points well within the main lobe of the antenna in question and penalizing points well off of the bore sight. The function f_{A} can be viewed as an approximation of the linear power gain of the sector antenna in question (with the maximum gain rescaled to unity).

In the special case of softer-handoff with the primary sector, only one distance and/or circle may be available, in which case the analysis may not appeal to the intersection of circles. One alternative approach is to find a point a distance R₀ away from the primary cell where the decibel difference in antenna gains 10 log₁₀(ƒ_{A}(φ,α₀,β₀)/ƒ_{A}(φ,αᵢ,βᵢ)) is closest to the observed difference in Ec/Io, Ec/Io₀−Ec/Ioᵢ. In the case of softer-handoff with the primary sector, there is no ambiguity of points. Note that any non-zero delay difference information (Dᵢ≠0) may be ignored (although some embodiments of the approach may take non-zero delay difference information into account). While non-zero delay differences could be associated with substantial multipath issues, it is believed that other mechanisms may be used to address this effect. Finally, note that non-primary softer-handoff (i.e., that does not involve the primary sector) is treated using the soft-handoff approach described earlier. It is not believed that the increase in algorithm complexity to address softer-handoff among non-primary sectors would yield substantially improved accuracy.

In embodiments that implement softer-handoff between sectors, the likelihood function can be written as:

$$L ( {P}_{k , l} ) = {f}_{Ec / Io} ( Ec / {Io}_{k} ) \cdot {\prod }_{i = 0}^{N - 1} {f}_{R , i} ( \vert {r}_{k , l , i} - {R}_{i} \vert ) \cdot {g}_{A , i} ( {ϕ}_{k , l , i} , {α}_{0} , {β}_{0} , {α}_{i} , {β}_{i} , Ec / {Io}_{0} , Ec / {Io}_{i} )$$

$$where \text{:}$$

$${g}_{A , i} ( {φ}_{k , l , i} , {α}_{0} , {β}_{0} , {α}_{i} , {β}_{i} , Ec / {Io}_{0} , Ec / {Io}_{i} ) = \{ \begin{matrix}{f}_{A} ( {φ}_{k , l , i} , {α}_{i} , {β}_{i} ) & SoftHandoff \\ {h}_{A} ( {φ}_{k , l , i} , {α}_{0} , {β}_{0} , {α}_{i} , {β}_{i} , Ec / {Io}_{0} , Ec / {Io}_{i} ) & SofterHandoff\end{matrix}$$

In one embodiment, the softer-handoff likelihood functional h_{A} is unity when the decibel difference in antenna gains 10 log₁₀(ƒ_{A}(φ_{k,l,0},α₀,β₀/ƒ_{A}(φ_{k,l,i},αᵢ,βᵢ)) is equal to the observed difference in Ec/Io values Ec/Io₀−Ec/Ioᵢ and decays to zero as the disparity between these two quantities increases. A softer-handoff situation may exist wherein the primary and secondary sectors are physically co-located and have the same cell number (note that due to multipath, this does not necessarily make the time difference of arrival equal to zero). In one embodiment, having an identical cell number may be insufficient because of the use of microcells in some markets (and two sectors having the same cell number may be widely separated).

In the case of softer hand off, a search of the neighborhood of the best point found using the maximum likelihood techniques described above may be performed. For example, the search may be performed over a suitably large and suitably fine grid of points centered about the best point, a new likelihood function L(Pⱼ) above is evaluated for grid point j:

$$L ( {P}_{j} ) = {f}_{Ec / Io} ( Ec / {Io}_{kbest} ) \cdot {\prod }_{i = 0}^{N - 1} {f}_{R , i} ( \vert {r}_{j , i} - {R}_{i} \vert ) \cdot {g}_{A , i} ( {ϕ}_{j , i} , {α}_{0} , {β}_{0} , {α}_{i} , {β}_{i} , Ec / {Io}_{0} , Ec / {Io}_{i} )$$

The new best point found over the grid is preserved and output along with the output of the likelihood function. The size of the grid may be determined by the accuracy of available data. Good results have been obtained with a grid point spacing of 48 meters across a total grid width of 1 kilometer.

Specific functional forms for maximum likelihood functions may be determined by experimentation. For the maximum likelihood functions discussed above, there are five different error likelihood functions that may be modeled:
Primary Distance: ƒ_{R,i}(|r_{k,l,0}−R₀|)
Secondary Distance: ƒ_{R,i}(|r_{k,l,i}−Rᵢ|) with i≠0
Offset Angle from the Primary Antenna: ƒ_{A}(φ_{k,l,0},α₀,β₀)
Offset Angle from the Secondary Antenna (non-softer): ƒ_{A}(φ_{k,l,i},αᵢ,βᵢ) with i≠0
Softer Handoff: h_{A} (φ_{k,l,i},α₀,β₀,αᵢ,βᵢ,Ec/Io₀,Ec/Ioᵢ)
   Market studies were performed using a combination of a drive test mobile (to determine accurate location via a Global Positioning System) and network monitoring software to extract network timing information of the drive test mobile. Various markets were studied that included different clutter and terrain topography. The collected data was used to determine the function forms of the likelihood functions. Results showed very similar functional forms and parameter values for all markets studied.

In one embodiment, a preferred likelihood function for the primary distance error is an exponential function of the form:
ƒ_{R,0}=e^{(-α}^{ₚᵣᵢₘ}^{·|r}^{_{k,l,0}}^{-R}^{ₒ}^{|)},
where r_{k,l,0} is the distance from the primary base station to the chosen solution point P_{k,l} and R₀ is the predicted distance based on RTD measurements.

A preferred likelihood function for the secondary distance error is an exponential function of the form:
ƒ_{R,i}=e^{(-α}^{_{sec}}^{·(r}^{_{k,l,i}}^{-R}^{ᵢ}⁾⁾,
where r_{k,l,i} is the actual distance from the i^{th} secondary to the chosen solution point P_{k,l} and Rᵢ is the predicted distance from the i^{th} secondary based on RTD and difference delay (also referred to as Time Delay of Arrival, or TDOA) measurements.

The probability of the mobile being served by a given base station is modeled to be greater if one is in the main beam of that base station's antenna pattern and decreases as one moves away from the main beam. Based on measurements in the aforementioned markets, a preferred likelihood function for the offset angle of the primary sector (i=0) may be written as:

$${f}_{A , 0} = \{ \begin{matrix}1 & \vert {ϕ}_{k , l , 0} - {α}_{0} \vert < \frac{{β}_{0}}{2} \\ {ⅇ}^{( - \frac{\vert {ϕ}_{k , l , 0} - {α}_{0} \vert - \frac{{β}_{0}}{2}}{11} )} & \vert {ϕ}_{k , l , o} - {α}_{0} \vert \geq \frac{{β}_{0}}{2}\end{matrix}$$

where |φ_{k,l,0}−α₀| is the offset angle from the primary sector to the solution point P_{k,l} and β₀ is the antenna beam width. In this case the fitting beamwidth is equal to the actual beamwidth of the antenna. It is interesting to note that there is an equal probability of being in handoff at the 3 dB point of the actual antenna pattern and at bore site using this likelihood function.

A preferred likelihood function for the offset angle for the non-softer secondary sectors may be written as:

$${f}_{A , i} ( {ϕ}_{k , l , i} , {α}_{i} , {β}_{i} ) = \{ \begin{matrix}{( 1 - 0.293 \cdot \frac{{( {ϕ}_{k , l , i} - {α}_{i} )}^{2}}{{( ( x \cdot {β}_{i} ) / 2 )}^{2}} )}^{2} & \vert {ϕ}_{k , l , i} - {α}_{i} \vert < \frac{x \cdot {β}_{i}}{2} \\ 0.5 \cdot {ⅇ}^{( - \frac{\vert {ϕ}_{k , l , i} - {α}_{i} \vert - \frac{( x \cdot {β}_{i} )}{2}}{\frac{( x \cdot {β}_{i} )}{4}} )} & \vert {ϕ}_{k , l , i} - {α}_{i} \vert \geq \frac{x \cdot {β}_{i}}{2}\end{matrix}$$

where |φ_{k,l,i}−αᵢ| is the offset angle from the i^{th} sector to the solution point P_{k,l} and βᵢ is the antenna beam width of the i^{th} sector. In this case the fitting beamwidth is larger than the actual beamwidth of the antenna.

A preferred likelihood function for the softer handoff case may be written as:
h_{A}(φ_{k,l,i},α₀,β₀,αᵢ,βᵢ,Ec/Io₀,Ec/Ioᵢ)=e^{-α}^{_{softer}}^{·|ΔE}^{_{c}}^{/I}^{ₒ}^{-ΔG}^{ⁱ}^{ₐₙₜ}^{|)}
where ΔE_{c}/Iₒ is the dB gain difference for the two softer handoff legs and ΔGⁱₐₙₜ is the antenna gain difference between the softer handoff legs (in dB) for solution P_{k,l}.

In some embodiments, the Ec/Io of the signal may be very low and the accuracy of the measurements may become suspect. A term to reduce the likelihood for low Ec/Io may be included. In one embodiment, the term is included in the secondary distance likelihood functional, which may then be written as:
P_{sec-dist}=e^{(-α}^{_{sec}}^{·(d}^{ᵢ}^{-d}^{_{TDOA}}^{)/(1+EcIoQuality))}
where

$$EcIoQuality = \{ \begin{matrix}0 & {E}_{c} / {I}_{o} > Threshold \\ \vert {E}_{c} / {I}_{o} - Threshold \vert & {E}_{c} / {I}_{o} \leq Threshold\end{matrix}$$

Also there is a possibility that a high likelihood score may be obtained for the softer handoff case for a solution in the back lobe of both softer handoff sectors because this solution still shows the proper antenna gain difference. In one embodiment, one may check that the front lobes of the antennas are being used.

Embodiments of the present invention have been compared to an Enhanced Forward Link TDOA (EFLT) geo-location algorithm. The techniques described above produced approximately a 25% reduction in the location when compared to the EFLT algorithm.

Embodiments of the present invention may be used (perhaps in concert with additional tools) to analyze a variety of network phenomena including, but not limited to:
Traffic density maps (as a function of service type)
Dropped/lost call density maps
Differential analysis (“before vs. after”, or trending)
Ec/Io spatial maps or distributions within a region
Number of pilots as a function of location
   Results may also be post-processed to allow for other types of analysis. For example, a cumulative distribution of the best pilot Ec/Io for all calls within a specified region may be determined. The best (i.e., strongest) Ec/Io may be chosen from among all observed sectors for each call and used to form an overall distribution across all calls within a specified region. This information, based entirely on subscriber experiences, may allow for critical insight into network operation and more effective network design, optimization and maintenance. Embodiments of the present invention may also provide substantial insight into network operation and allow subscribers to “speak for themselves” regarding the spatial performance of a CDMA network.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of communication with a mobile unit, comprising:
determining at least one distance associated with the mobile unit in communication with at least one base station;
determining a first location based on said at least one distance;
selecting a plurality of second locations based on the first location; and
determining a plurality of likelihoods that the mobile unit is at each of the plurality of second locations.

2. The method of claim 1, wherein determining said at least one distance comprises determining a first distance between the mobile unit and a first base station.

3. The method of claim 2, wherein determining the distance between the mobile unit and the first base station comprises determining the distance between the mobile unit and the first base station based upon a round-trip delay.

4. The method of claim 2, wherein determining the first location comprises determining the first location based upon network information.

5. The method of claim 4, wherein determining the first location based upon network information comprises determining the first location based upon at least one of a latitude associated with the first base station, a longitude associated with the first base station, at least one sector azimuth of at least one antenna associated with the first base station, at least one beam width of said at least one antenna, a gain map for said at least one antenna, and a phase offset.

6. The method of claim 2, wherein determining said at least one distance comprises determining at least one second distance between the mobile unit and at least one second base station.

7. The method of claim 6, wherein determining said at least one second distance comprises determining said at least one second distance based upon at least one of a round-trip delay and a delay difference.

8. The method of claim 6, wherein determining the first location comprises:
forming a plurality of circles, each circle having a center proximate the first or second base stations and a radius equal to one of the first or second distances; and
determining whether the plurality of circles have any intersection points.

9. The method of claim 8, wherein determining whether the plurality of circles have any intersection points comprises determining whether the plurality of circles intersect within a tolerance.

10. The method of claim 8, wherein determining the first location comprises determining at least one likelihood that the mobile unit is at one of the intersection points in response to determining that the plurality of circles have at least one intersection point.

11. The method of claim 10, wherein determining the plurality of likelihoods comprises determining the plurality of likelihoods using a maximum likelihood function.

12. The method of claim 10, wherein determining the first location comprises selecting one of the intersection points as the first location based on said at least one likelihood.

13. The method of claim 12, wherein selecting one of the first locations based on the plurality of likelihoods comprises selecting the first location having the largest likelihood.

14. The method of claim 8, comprising detecting at least one error in response to determining that the circles do not intersect.

15. The method of claim 1, selecting the plurality of second locations based on the first location comprises selecting a grid of second locations centered on the first location.

16. The method of claim 1, wherein determining the plurality of likelihoods that the mobile unit is at each of the plurality of second locations comprises determining the plurality of likelihoods based upon at least one of a latitude associated with said at least one base station, a longitude associated with said at least one base station, at least one sector azimuth of at least one antenna associated with said at least one base station, at least one beam width of said at least one antenna, a gain map for said at least one antenna, and a phase offset.

17. The method of claim 1, wherein determining the plurality of likelihoods comprises determining the plurality of likelihoods using a maximum likelihood function.

18. The method of claim 1, comprising selecting one of the second locations based on the plurality of likelihoods.

19. The method of claim 18, wherein selecting one of the second locations based on the plurality of likelihoods comprises selecting the second location having the largest likelihood.

20. The method of claim 1, comprising detecting at least one error in network information based on the plurality of likelihoods.

21. The method of claim 20, wherein detecting at least one error in said network information comprises:
modifying a portion of said network information; and
determining a plurality of likelihoods that the mobile unit is at each of the plurality of second locations based upon the modified network information.
